(19) United States
(12) Patent Application Publication
(10) Pub. No.: US 2014/0305962 A1
(43) Pub. Date: Oct. 16, 2014

(54) DISPENSER AND DISPENSER SYSTEM FOR AT LEAST ONE COMPONENT OF A CUP SYSTEM, IN PARTICULAR A PAINT CUP SYSTEM

(71) Applicant: SATA GmbH & Co. KG, Kornwestheim (DE)

(72) Inventors: Alexander TSCHAN, Kornwestheim (DE); Ewald SCHMON, Grafenberg (DE); Peter DETTLAFF, Remseck (DE); Michael PANTLE, Gemmrigheim, DE (US); Ralf SEITER, Mainhardt, DE (US)

(73) Assignee: SATA GmbH & Co. KG, Kornwestheim (DE)

(21) Appl. No.: 14/249,596

(22) Filed: Apr. 10, 2014

(30) Foreign Application Priority Data
Apr. 11, 2013 (DE) 202013101550.4

(51) Int. Cl. G07F 11/04

(52) U.S. Cl. CPC G07F 11/045
USPC 221/221

(57) ABSTRACT

Dispenser for at least one component of a cup system, in particular a paint cup system. The dispenser includes at least one receiving body for receiving the component and an arrangement for releasing the component, with the dispenser including at least one fastening element for releasable attachment of the dispenser to a holding device.

### FIELD OF THE DISCLOSURE

The disclosure relates to a dispenser for at least one component of a cup system, in particular a paint cup system, and to a dispenser of the same type and also to a dispenser system for at least one component of a cup system, in particular a paint cup system.

### BACKGROUND OF THE DISCLOSURE

Paint cups for use with spraying apparatuses, in particular spray guns, can be designed as reusable cups and also as disposable cups. Reusable cups can be designed as gravity-flow cups, side-mounted cups or suction cups. Paint cups can accommodate different liquids, such as clear paints, finishing paints and fillers, but also water adhesives, liquids for the food industry or other free-flowing substances.

Reusable cups designed as gravity-flow cups consist substantially of a relatively thick-walled plastic or aluminium container, at the lower end of which a connection means, generally made of metal, for fitting and fastening the cup on a spray gun or an adapter fastened thereon is provided. Furthermore, the cup consists of a lid, which is likewise relatively thick-walled, having a ventilation opening that can be closed by means of a removable stopper.

Disposable cups are in principle intended for one-time use and generally comprise a thinner-walled conical, partly conical or cylindrical container made of plastic and a lid that can be fitted thereon in order to close the container. Connection means for fitting and fastening the gravity-flow cup on a paint spray gun or on an adapter attached to a spray gun can be provided in the case of disposable cups on the upper side of the lid. Furthermore, a disposable cup system often comprises at least one sieve, which is arranged before the inflow to the spraying apparatus in order to filter out undesired particles. This sieve can be designed as a flat sieve or as a plug-in sieve (cylinder sieve). Flat sieves consist of a normally circular straining cloth and a frame arranged at the periphery of the cloth. Flat sieves are used in the central region of the cup lid, which is normally conical at least in some regions. Plug-in sieves have a cylindrical shape with frames on the base and lid faces as well as a plurality of supports on the lateral surface and straining cloth arranged therebetween. Plug-in sieves are inserted into the outlet opening of the cup lid.

Particularly in the case of disposable cups, the different components, that is to say container, lid, plug-in sieve and flat sieve, are normally stored separately from one another. Containers and lids are each generally provided in stacked form and are only brought together shortly before use.

The different components are often stored in their packaging. With some packagings, the lid may be cut in part and folded open so as to be able to receive the components. For space-saving storage of the packagings, special stands exist that are designed to receive the packagings one above the other. Here, it is not possible however to store all required components of the cup system beside one another, since although the containers and the cup lids are generally arranged together in one packaging, the sieves are provided separately. Furthermore, a disadvantage of these stands is that the components of the cup system are only insufficiently protected against contamination, since the packaging cannot be fully reclosed. The packaging consists of cardboard, as a result of which there is a risk that it will become soft as a result of paint mist, solvent or other moisture. In addition, the storage of the components in boxes looks untidy and unordered, which may create a negative impression among customers.

Besides these stands for storing packagings for components of a cup system, there are also dispensers for different components of such a system, said dispensers being designed to receive the individual components. A known device for storing cup lids is provided in the form of a box that can be fixedly mounted on a wall. This box, on its upper side, has a lid which can be opened in order to fill the box. Furthermore, the box, on its front side, has a round opening which can be covered by a flap and through which the stored components can be removed. Such a box is used to store and dispense cup lids. The lids are thrown into the box loosely and in an orderless manner.

A disadvantage with this solution is that, due to the unordered filling of the box with the lids, the space available in the box cannot be utilized ideally. Ordered filling of the box is not expedient, since in this case the removal of the lids through the opening is hindered. In addition, the flap in front of the opening has to first be lifted in order to be able to remove a lid. The user requires both hands to remove a lid because the flap has to be held open constantly. Furthermore, there is the risk that two or more lids will become hooked together in the box and more than just one lid will be removed undesirably. The additional lid removed accidentally may detach from the first lid once removed and may fall onto the floor, whereby the lid may be undesirably contaminated and/or damaged.

Dispensers similar to known dispensers for beverage cups for example exist for the storage and delivery of the containers for the cup system or for what are known as liners for the containers. A flap for filling with the containers or the liners is again located on the upper side of this dispenser formed as a vertically elongate box. The containers or liners are stacked and are introduced into the box with the base arranged to the bottom. A round opening, of which the diameter is slightly smaller than the diameter of a collar located on the upper cup rim or liner rim, is located on the underside of the box. The components stacked one inside the other therefore fall downwardly in the box until the collar of the lowermost cup or liner bears against the edge of the opening. To remove a cup or liner, the lowermost cup or liner is pulled away downwardly, whereupon the cups arranged thereabove slide down and are again held by the cup which is now the lowermost cup and which bears against the edge of the lower opening.

A disadvantage of this solution is that an extra dispenser is necessary for each container or liner size, since the lower opening of the dispenser is only dimensioned for one cup size. However, different cup sizes are available on the market and are used by the users for different jobs, depending for example on the size of the area to be painted. If dispensers are to be offered for different container sizes, the manufacturer of the dispensers must develop and fabricate different variants of his dispenser, which is associated with costs. Furthermore, with the mentioned container dispensers or liner dispensers, there is the risk that, when removing a container or liner, a further container adheres to the lowermost container or liner and is accidently also removed. The unintentionally removed part then has to be placed back in the dispenser.

The cup stack may additionally be rather heavy, such that the edge of the opening is not able to withstand this weight; the edge may potentially have to be designed so as to be so wide that the removal of the individual parts is difficult.

With both solutions, it is additionally disadvantageous that the mounting to the wall for each dispenser has to be carried out as an extra procedure. If the dispenser system is to be expanded by one dispenser, this has to be mounted on the wall in a relatively complex manner. It is very difficult for one person alone to carry out the mounting process. Fastening holes, by means of which the dispensers can be hung on screws are located on the rear side of the dispensers. If a dispenser is to be assembled by just one person, this person must therefore first establish the distance between the two fastening holes on the rear side of the dispenser and must then screw the two screws into the wall at the correct distance and exactly horizontally in relation to one another before the person can hang the dispenser. It may still be necessary for the screws to be screwed tightly. This procedure is necessary for each individual dispenser. Once mounted on the wall, the dispensers cannot be easily removed therefrom again. The screws have to be loosened first before the dispensers can be taken down and the screws removed completely from the wall. The exchange of the dispensers is thus hindered. If, in addition, the wall is not completely flat, the dispenser will be held poorly. A further problem arises when the dispenser is to be used by a number of individuals of considerably different size. If the dispenser hangs relatively low, a tall person may have difficulty in removing the components, in particular the containers or the liners. If the dispenser hangs higher, a shorter person may encounter problems when filling the dispenser, in particular the dispenser for the containers or the liners, since this is relatively long in the vertical direction so as to house a maximum number of items. The upper flap for filling the dispenser is therefore located much higher than the lower opening for removal of the components. At the same time, when stacked one inside the other, the containers or liners that are to be inserted into the dispenser form a relatively high stack that has to be introduced into the dispenser.

As an alternative to fastening by means of screws, the described dispensers can be fastened to the wall by means of double-sided adhesive tape. The load-bearing capacity of such a connection is not comparable however to a screwed connection. Furthermore, the dispenser may detach from the wall over time, in particular if this wall is not always dry, which may cause damage to the dispenser. The wall also has to be very clean and dust-free before the attachment of the dispenser. Removal and subsequent reattachment of the dispenser also is not possible here, since the adhesive tape in this case would lose a large part of its adhesive force.

Furthermore, with known dispenser systems, there is no possibility for the independent storage and delivery of plug-in sieves and flat sieves.

### SUMMARY OF THE DISCLOSURE

An embodiment of the disclosure is directed to a dispenser system for a plurality of components of a cup system, in particular of a paint cup system, which protects the components of the cup system against contamination, is resistant to moisture, and with which the components of the cup system are arranged in an ordered state. An embodiment of the disclosure is directed to a dispenser system that can be quickly and easily matched to different cup sizes. An embodiment of the disclosure is directed to a dispenser system that is space saving, in which the removal of the components is easier compared to dispensers according to the prior art and with which the components are separated reliably during the removal process. An embodiment of the disclosure is directed to a dispenser system that can be easily assembled, disassembled and expanded, and with which the filling process is simplified.

According to an embodiment of the disclosure, a dispenser for at least one component of a cup system, in particular a paint cup system, comprises at least one receiving body for receiving the component and an arrangement for releasing the component, wherein the dispenser further comprises at least one fastening means for releasable attachment of the dispenser to a holding device.

An embodiment of the disclosure is directed to a dispenser for at least one component of a cup system, in particular a paint cup system, wherein the dispenser is designed to receive an adaptor which makes the dispenser suitable for use with different or various components of the cup system.

An embodiment of the disclosure is directed to a dispenser system for at least one component of a cup system, in particular a paint cup system, said dispenser system comprising at least one dispenser, wherein the dispenser system further comprises a holding device for releasable attachment of the at least one dispenser.

Other embodiments are also disclosed herein.

In an embodiment, the dispenser according to the disclosure is not screwed or adhered directly to a wall, but instead the attachment is achieved via at least two holding means corresponding to one another, wherein one of said holding means is arranged or can be arranged on the dispenser and a counter element is arranged or can be arranged on the wall. The two holding means are preferably hung, plugged, clipped, slid, pivoted, screwed or turned one inside the other or are otherwise interconnected, for example via magnets or pneumatic means. For example, the holding device on the wall may be designed in the form of an L-shaped, Z-shaped or U-shaped aluminium profile. The fastening means on the dispenser is designed in such a way that it corresponds to the shape of the holding device and can be hooked into the holding device. The fastening means preferably has an L-shaped, U-shaped or Z-shaped region for this purpose.

The term “wall” is always to be understood hereinafter to mean any substantially vertical surface, in particular also doors or the like.

In the present case, cup system means that the cup intended for use consists of a plurality of components, for example of a container, that is to say the actual cup, a lid and one or more filters. Other or further components may also be provided however.

The present dispenser and the present dispenser system are particularly suitable for disposal cups, but may also be designed for use with reusable cups. In this case, merely some design changes are necessary and may also lie within the scope of the disclosure however.

In some embodiments, the dispenser according to the disclosure preferably comprises a suspension device for storing the component or the components in a suspended manner. For example, the component may be the lid of a cup system, which, as already mentioned, may, on its upper side, have connection means for fitting and fastening the cup on a paint spray gun or an adapter fastened thereon. The connection means have an opening with a diameter of approximately 10 to 13 mm, often approximately 11.5 mm, wherein lids for smaller cups in particular may have smaller diameters, for example between 4 and 7 mm, in particular 5.5 mm. The suspension device is preferably designed in such a way that a plurality of cup lids stacked one above the other can be threaded thereonto. A stop device is located on the lower region of the suspension device and prevents the threaded-on cup lids from slipping from the suspension device when the suspension device is erected vertically. The stop device or the entire suspension device can be designed as a brush, in particular as a circular brush, rotated brush, perforated brush, cylinder brush or tube brush, or may contain at least one such brush, which preferably consists of a turned wire, at the lower region of which a multiplicity of outwardly directed bristles is incorporated. The use of at least one clamping sleeve, tubular sleeve or other sleeve is also possible. Once the lids have been threaded onto the suspension device, the suspension device is lifted at its side remote from the stop device. An eyelet or loop is preferably located on this side of the suspension device. This eyelet or loop is fastened with the aid of a rivet or another fastening means preferably to a dispenser lid, which can be fitted onto the receiving body of the dispenser. The suspension device with the cup lids now hangs within the receiving body. The suspension device is expediently approximately exactly as long as the receiving body or longer, such that the cup lids protrude from beneath from the receiving body. The cup lids can then be easily removed from the suspension device from beneath.

The suspension device does not necessarily have to be fastened to a dispenser lid, but can also be attached for example merely to a pin, which is disposed horizontally on the upper edge of the dispenser or receiving body thereof. Notches can be provided and ensure that the pin is held securely.

The suspension device can be provided over its entire length with bristles or only in parts or in regions. The bristles preferably take up one eighth to one twelfth of the total length of the suspension device and are located completely at the lower end of the suspension device. If the region with the bristles is too short, the weight of the cups will be greater than the frictional force between the bristles and components. In this case, the components will slip from the suspension device. If the bristle region is too large, the components will be held too high up and will no longer be accessible or will only be accessible with difficulty. The length of the necessary bristle region is dependent inter alia on the length, thickness, shape and surface of the bristles, on the weight of the components and also on the contact area between components and bristles.

The suspension device does not necessarily have to be designed as a brush, but may also have a different structure and a different assembly. In particular, the stop device can be designed differently, for example harpoon-shaped with a plurality of barbs arranged along the periphery and the length. The components are held by the barbs and can be removed therefrom downwardly, wherein the components may be slightly deformed. Other stop devices may also be provided however. A plurality of different stop devices are also conceivable, in particular those having a braking effect of different intensity for the components. For example, a stop device with weak braking effect can be provided at the upper region of the suspension device in order to relieve a further stop device at the lower end of the suspension device.

The component provided in the dispenser with suspension device for suspended mounting does not necessarily have to be the cup lid. Rather, other components can also be mounted in such a way, for example the cup container, that is to say the cup itself. This is then possible in particular when an opening is provided in the cup base, for example in the form of a valve, that can be closed by means of a stopper. The suspension device can be passed through this opening in the cup base, and the cup container can thus be threaded onto the suspension device. The stoppers for the cup valves can be stored in a suitable dispenser.

The filling process is preferably implemented in any case as follows: the lid of the dispenser is removed from the dispenser together with the suspension device arranged on the lid. The components of the cup system which are to be held by the suspension device, that is to say which are to be stored in the dispenser by means of the suspension device, are advantageously stacked in such a way that their openings, through which the suspension device is to be passed, are arranged substantially one above the other. The suspension device, in particular if produced from twisted wire, is preferably flexible, but is capable of taking up compressive forces up to a certain extent. It is thus possible to pass the suspension device through the stack of components from above, preferably until the passed-through end of the suspension device protrudes considerably from the component stack from beneath. The components are particularly preferably threaded on oriented in such a way that the suspension device, once it exits from the last component opening, is still surrounded by walls of the component. In other words, the cup lids are preferably oriented with the connection device arranged to the top, and the cup containers are preferably oriented with the valve opening arranged to the top. Once the passed-through end of the suspension device leaves the opening in the lowermost component in the stack to be threaded on, this end in the case of the lids is thus still located within the lid walls, or in the case of the cup containers is still located within the cup. The lower end of the components may thus be located beneath the end of the suspension device, whereby the suspension device may be shorter than would be the case with a different orientation of the components. The suspension device is also protected from sight by the components and is protected against external influences, which may increase its service life. Once threaded on, the suspension device including the components is lifted on the dispenser cover side of the suspension device until the components are still held only by the suspension device. The suspension device with the components is then introduced into the receiving body of the dispenser until the dispenser cover rests on the receiving body. The dispenser cover may be pressed on in order to ensure an improved seal and a more reliable hold of the dispenser lid and of the suspension device. The dispenser lid may also be screwed on, or another connection may be provided.

The receiving body of the dispenser is preferably designed as an elongate hollow body, particularly preferably as a tube with a slightly larger diameter than the components to be received. The receiving body preferably consists of a cardboard tube that is provided with a protective coating, in particular a protective film. The receiving body may also be made of plastic, glass or metal however, in particular a light metal such as aluminium. One or more viewing windows for indicating the fill level may be provided. Viewing windows or other fill level indicators can be omitted however if the receiving body is produced from a transparent or translucent material.

In an embodiment of the dispenser according to the disclosure, the arrangement for releasing the component is designed as a collecting tray, in particular for plug-in sieves. The collecting tray is preferably trough-shaped, wherein approximately half the collecting tray is located beneath the receiving body of the dispenser. The collecting tray may be connected or connectable to the receiving body via a plug-in, snap-fit, screw, bayonet or clip mechanism or in another way, for example via magnets. An intermediate piece may also be provided between the collecting tray and receiving body. The other half of the collecting tray protrudes beneath the receiving body. This open region can be provided with a flap, a slide or another cover. A lid for the receiving body may also be provided in order to protect the components stored therein.

This embodiment of the dispenser according to the disclosure is particularly suitable for the storing of loose components of the cup system that cannot be stacked. Besides plug-in sieves, valve stoppers or other elements may also be used here.

The components are poured into the receiving body once a lid, which may or may not be provided, has been removed, whereupon they fall into the collecting tray and slide in the direction of the open half of the collecting tray. There, they are then ready for removal.

In a further embodiment of the dispenser according to the disclosure, the arrangement for releasing the components comprises, on its underside, at least two tongues and, on at least one other side, a slitted opening. The two tongues are preferably horizontally aligned and arranged beneath the opening in the receiving body of the dispenser. The distance between the two tongues is preferably two to nine centimetres. This embodiment of the dispenser according to the disclosure is particularly suitable for flat components of the cup system, in particular for flat sieves. The flat sieves are preferably allowed to fall as a stack into the receiving body of the dispenser. In order to ensure that all sieves are arranged horizontally in the receiving body, it may be necessary to shake the receiving body. The sieves are now arranged on the two tongues of the arrangement for release of the components. To guide the sieves in the dispenser, guiding arrangements, for example in the form of guiding edges or guiding webs, may be provided. The device, preferably on its front side, has a narrow horizontal opening, of which the height is preferably slightly larger than the height of the component to be released, but is smaller than twice the height thereof. To remove a flat sieve, the user presses lightly from beneath against the sieve arranged on the tongue and exposed downwardly in part by the distance between the tongues and then moves the sieve in the direction of the slitted opening. Due to the mentioned dimensioning of the opening, it is ensured that only one sieve is released.

In a further preferred embodiment of the dispenser according to the disclosure, the arrangement for releasing the component is designed in such a way that it corresponds to at least one thread of the component. The component with thread may in particular be the cup container of a cup system. In order to correspond to a thread of a component, the arrangement for release may be provided with a corresponding counter thread or counter thread part, however only pins or lugs may also be provided, which are designed in such a way that they engage in the thread on the component and the component releases upon rotation of the component in a specific direction.

The dispenser preferably has at least one arrangement for displaying user information, which indicate the correct use of the dispenser, correct filling thereof, correct assembly thereof or other information concerning the dispenser. This display is particularly preferably arranged on the receiving body. The display may be present for example in the form of images, in particular pictograms.

At least one fastening means for releasable attachment of the dispenser to a holding device is preferably connected or connectable to a component part of the dispenser in a position-dependent manner. This means the fastening means is designed in such a way that it can be attached only at a specific point of the dispenser or is already attached there. The component part of the dispenser and the fastening means particularly preferably form a structural unit, or the component part of the dispenser comprises said fastening means. The component part is preferably the arrangement for release of the component or part thereof or is a reinforcement ring. It may also be the above-mentioned intermediate piece between a collecting tray, in particular for plug-in sieves, and the receiving body of the dispenser however. These component parts can be provided with a fastening means for releasable attachment of the dispenser to a holding device. The fastening means may however also be arranged on a component part of the dispenser that merely or particularly serves to take up and/or forward the forces taken up by the fastening means. Here, this may be a ring or part ring for example, which is attached or can be attached releasably or non-releasably to the lower edge of the receiving body of the dispenser and is provided with a fastening means for a releasable attachment of the dispenser to a holding device. This fastening means can be used to support the majority of the weight of the dispenser.

In addition, at least one fastening means can preferably be attached to the dispenser for releasable attachment of the dispenser to a holding device by means of an adhesive, detent, snap-fit or other rapid connection, for example a magnetic connection or a pneumatic connection. This fastening means can be attached releasably or non-releasably to the dispenser. If the fastening means is provided for a non-releasable attachment or if release is not possible without causing damage to a component part, the fastening means is provided as a component part that is to be attached subsequently, that is to say it is only attached to the dispenser once the dispenser has been attached to the wall. Should the connection between the dispenser and fastening means be releasable, the fastening means may already be connected to the dispenser in order to prevent the component part from becoming lost. Before the attachment of the dispenser to the wall, the fastening means has to be removed from the dispenser however and can only be refastened thereto once the dispenser has been attached to the wall in order to be able to achieve the advantages according to the invention. This form of the fastening means is therefore also referred to as a “fastening means to be attached subsequently”. The fastening means can be provided for example in the form of an adhesive pad, which has a shape corresponding to the holding device and also has an adhesive area, via which the fastening means can be adhered to the dispenser, in particular to the receiving body of dispenser. The adhesive area is at least partly flexible, whereby it can adapt to differently sized receiving containers. The adhesive area is preferably provided with a protective film, which prevents an unintentional adhesive bonding of the fastening means to another body and prevents wear of the adhesive area. The protective film can be removed shortly before the fastening means is adhesively bonded to the dispenser. The adhesive area may also not be self-adhesive however, but it may be necessary to provide the adhesive area with an adhesive. The described fastening means is advantageously a fastening means that is provided in addition to the above-described fastening means connected non-releasably to a component part of the dispenser. The two fastening means can preferably be arranged on the dispenser so as to be as far removed from one another as possible, such that the dispenser can be attached to the holding device in a manner secured against rotation and tilting. Each of the two fastening means may also be present without the other, both individually and a number of times. At least one fastening means can preferably be attached to the dispenser in a position-independent manner. This means that the fastening means, conversely to the holding device connected non-releasably to a component part of the dispenser, can be attached to the dispenser at practically any location. The position-independent fastening means can particularly preferably be attached at any desired point of the receiving body of the dispenser. The fact that the fastening means can be attached in a manner independent of position can be achieved in particular with the above-described adhesive pad. This can be attached at any point of the dispenser, at least at any point of the receiving body.

Instead of adhesive pads, hook-and-loop bands or the like may also be provided for fastening purposes. The use of such fastening means, which are normally prefabricated in a ready-to-use state, is advantageous both in terms of handling and economic viability. On the other hand, rivet connections, screw connections or the like may also be provided. The presence of a fixed fastening means and of a fastening means that can be attached in a manner independent of position, in particular subsequently, for releasable attachment of the dispenser to a holding device is then in particular advantageous if at least two holding points are provided with the holding device. This is the case for example if the holding device comprises at least two rails which are arranged horizontally and one above the other on a wall. The dispenser is to be attached to these rails via the fastening means. In order to fasten the dispenser to the holding device in the best possible way, the fastening means on the dispenser must be arranged at exactly the same distance from one another as the rails. With a number of fastening means attached fixedly to the dispenser, this is only possible if the distance between the rails is matched to the distance between the fastening means. If more than one dispenser is to be arranged on the rail, the distance between the two rails would have to be identical at all points if the distance between the fastening means of the dispenser is also identical. The rails would therefore have to be attached exactly parallel to the wall, which may pose a great difficulty for an individual person. If, with one dispenser, the distance between the fastening means is not identical to the distance with another dispenser, for example due to production inaccuracies or differences in size, it may be that the two dispensers cannot be attached together to the same rail.

With the presence of one fixed and one position-independent fastening means for releasable attachment of the dispenser to a holding device, the attachment can be implemented as described hereinafter, wherein an attachment to two rails is described by way of example. The rails are attached, in particular screwed, to a wall or to another object, for example a door. The rails preferably have a Z-shaped or U-shaped profile with sides arranged at right angles to one another. The rails are arranged horizontally and substantially parallel to one another. The position-independent fastening means has a shape corresponding to the profile of the holding device or can be matched to said profile. The position-independent fastening means is hooked or inserted into one of the rails or is otherwise brought into contact with the rail in such a way that it remains on the rail independently. A protective film located on the adhesive area of the fastening means can be removed from the adhesive area either before the fastening means is brought into contact with the rail or after. The fastening means connected fixedly to the dispenser likewise has a shape corresponding to the profile of the holding device and can be hooked or inserted into the second rail or otherwise brought into contact with the rail. The fastening means connected fixedly to the dispenser is designed to support the majority of the weight of the dispenser. The dispenser is advantageously held at an incline when the fastening means connected fixedly to the dispenser is brought into contact with the rail. It is then ensured that the position-independent fastening means is located substantially vertically on the rail above and below the fastening means connected fixedly to the dispenser. If this is the case, the dispenser is pivoted upwardly or downwardly and pressed against the position-independent fastening means. Due to the adhesive area, the dispenser then adheres to the fastening means and is held securely on the rails by the two fastening means. Since the fastening means are hooked merely into the rails, the dispenser can be easily removed from the wall, for example in order to facilitate the filling process. If three or more fastening points are desired, one fastening means connected fixedly to the dispenser and two or accordingly more position-independent fastening means are advantageously provided. The attachment is implemented accordingly.

The position-independent fastening means may also be position-independent in only one direction, preferably in the vertical direction. For example, the receiving container of the dispenser may have, on its rear side, a vertical groove with an undercut, and the position-independent fastening means may have a lug, a hook or other element that snaps into said groove. It can thus be ensured that the dispenser is arranged exactly perpendicular to the holding device. The degree to which the fastening means can be arranged in a manner independent of position can also be limited by providing a plurality of prefabricated points for the attachment of the fastening means. For example, a plurality of small openings, into which a fastening means provided as a snap-fit means can snap, can be provided on the rear side of the receiving body. Here, the opening that matches best by position can be selected.

A further dispenser according to the disclosure for at least one component of a cup system, in particular a paint cup system, is designed to receive an adapter, which makes the dispenser suitable for use with different or various components of the cup system. The dispenser can thus be matched quickly to different or differently sized components. The basic component parts can be retained. For example, the dispenser for the cup containers may initially be designed for the storage and release of large cups, for example having a volume of 0.9 litres. With the aid of an adapter, the dispenser can also be adapted for use however with smaller cups, for example with a volume of 0.6 or 0.3 litres. The use of the dispenser with different cup sizes is often not easily possible, since the cups sometimes differ in terms of the diameter of their opening. The adapter can be formed as a ring, ring segment, flat part or the like. The ring may have a smaller diameter than the standard arrangement for release of the cups, said arrangement preferably likewise being formed as a ring. The adapter may also comprise a different counter element for a thread, whereby the dispenser can be adapted for use with cups having different threads.

Similarly, an adapter can also be designed for a dispenser of flat sieves. Depending on the size of the cups or the cup lids into which the flat sieves are to be inserted, the flat sieves also have different diameters. The dispenser can be adapted for use with smaller flat sieves, here too by inserting a ring of smaller diameter into the standard arrangement for release of the flat sieves.

In one embodiment, the dispenser system according to the disclosure for at least one component of a cup system, in particular of a paint cup system, comprises at least one dispenser and one holding device for releasable attachment of the at least one dispenser.

The dispenser system is preferably formed in a modular manner and can be equipped with different dispensers. The dispenser system consists of different structural elements, in particular holding means, holding devices and dispensers, which can be joined together and combined practically arbitrarily. Different dispensers can be attached arbitrarily to the holding device and removed again. The dispensers can be designed for example for use with different components of a cup system and may have different sizes or different or different numbers of holding points. Some dispensers may also be combined to form a group and then attached to the holding device. The modularity is achieved in that the dispensers have similar fastening means, which correspond to a common holding device. For the purpose of modularity, at least one position-independent fastening means is also provided for releasable attachment of the dispenser to a holding device, since tolerances, in particular with regard to the fastening means, can thus be balanced and the dispensers can be attached to a common holding device.

The dispenser system can particularly preferably be equipped, that is to say fitted, at least with one dispenser for paint cup containers, one dispenser for paint cup lids, one dispenser for flat sieves and one dispenser for plug-in sieves. All components of a standard paint cup system can thus be stored close to one another and, when they are required, are quickly available without having to spend a long period of time looking for them at different locations.

At least one dispenser of the dispenser system is preferably designed as described above.

The holding device of the dispenser system preferably comprises at least one column and a plurality of receiving arrangements for receiving at least one fastening means of a dispenser. Here, any rod-shaped arrangement that has sufficient strength in order to support the objects attached thereto can be used as a column. The column is particularly preferably a metal rod with a diameter of at least one centimetre or a metal tube with the same outer diameter. The column may consist of a number of rods or tubes, which can be fitted into one another in a telescope-like manner. It is thus possible to adjust the height of the column and therefore of the holding device. The position of the rods or tubes relative to one another and therefore the overall length of the column and the height of the holding device can be maintained with the aid of a fixing arrangement. This can be formed for example as a rotary knob, which jams or presses together the rods and tubes fitted inside one another by means of tightening. A plurality of receiving arrangements for receiving the fastening means of the dispenser are arranged on the column. The receiving arrangements are arranged on the column, preferably around the column. For example, at least one multi-sided plate can be provided, which, preferably in its centre, is penetrated by the column. The plate preferably has five to ten sides and particularly preferably seven sides. The edges of the plates can be bent upwardly substantially vertically, whereby the receiving arrangements are formed. Corresponding fastening means on the dispenser can be hooked into said receiving arrangements. Of course, the receiving arrangements may also be designed differently, for example as part of a plug-in, snap-fit, screw, bayonet, clip, magnetic, pneumatic or other mechanism. The plates can be attached rotatably to the column. This has the advantage that dispensers that are arranged on the side facing away from the user can be turned towards the user by rotating the plates. Said dispenser is thus more easily accessible for the user. The receiving arrangements do not have to be arranged on plates, but can also be fastened on webs which may be arranged on the column in a star-shaped manner. The webs can be arranged horizontally or at an incline and can be reinforced with struts or supports. The use of belts, cords or the like is also possible.

The receiving arrangements are preferably arranged on the holding device in at least two planes. For example, two or more of the above-described plates with receiving arrangements can be arranged one above the other at some distance. This has the advantage that the dispensers, as already mentioned, can be formed in a tubular manner and can be held at two or more points. A tilting of the dispensers can thus be prevented. With shorter dispensers, for example with dispensers for plug-in sieves or flat sieves, only one single holding point may be provided. In this case, it is possible to attach the shorter dispensers at different planes of the holding device, advantageously substantially directly one above the other. A space saving can thus be achieved. The dispenser can also be attached to and removed from the holding device just described in a manner similar to that in the case of a holding device in the form of the above-described rails, with the difference that no rails have to be mounted here. The assembly of the holding device just described may potentially be necessary.

The holding device may comprise at least one plate for standing the holding device on the floor. The holding device and the dispenser can thus be positioned at any point in space. The dispenser system is not bound to a fixed location and is thus more versatile. An attachment of the holding device to the wall can be omitted. This is then advantageous in particular if the space on the wall is severely limited, or if the dispenser system is to be used at different locations. The column of the holding device advantageously stands vertically on the centre point of the plate. The column can be attached rotatably on the plate and/or can be removable therefrom.

The holding device may comprise at least one arrangement via which the holding device can be mounted to a wall. This arrangement, for example, may be a wall holder consisting of a horizontal part and a strut on the underside of the column and a horizontal part on the upper side of the column. The weight of the dispenser system can thus be taken up optimally. The column may also be attached here rotatably to the arrangement. Furthermore, the column can be removable from the arrangement. The column may additionally be provided with a base plate or insertable into such a base plate in order to make the column suitable both for attachment to a wall and for standing on the floor. Of course, the arrangement for mounting the holding device to the wall may also be formed differently from the manner described above. It is preferably designed such that the column is distanced from the wall so that there is sufficient space for the dispensers between the wall and column.

The holding device may comprise at least one rail that can be mounted to a wall. This rail can be designed similarly to the rail already described above. The rail may also be designed in such a way that the arrangement just described for mounting the holding device can be arranged on the wall. For example, the arrangement can be hooked into the rail and mounted slidingly along the rail. The dispenser system can thus be mounted on the wall, but at the same time offers a specific degree of versatility with regard to the position of the dispensers. A holding device other than a holding device designed with a column can also be fitted with at least one rail however.

The holding device preferably comprises at least one L-shaped, U-shaped or Z-shaped region, and the fastening means on the dispenser comprises a corresponding L-shaped, U-shaped or Z-shaped region, whereby the fastening means can be hooked into the holding device.

### BRIEF DESCRIPTION OF THE DRAWINGS

Some exemplary embodiments of the dispensers according to the invention and of the dispenser system according to the invention will be explained in greater detail hereinafter on the basis of the following drawings, in which:

FIG. 1 shows a first exemplary embodiment of a dispenser according to the invention, designed as a dispenser for cup containers,

FIG. 2 shows a second exemplary embodiment of a dispenser according to the invention, designed as a dispenser of cup lids,

FIG. 3 shows a third exemplary embodiment of a dispenser according to the invention, designed as a dispenser for flat sieves,

FIG. 4 shows a fourth exemplary embodiment of a dispenser according to the invention, designed as a dispenser for plug-in sieves,

FIG. 5a shows a first view of an exemplary embodiment of a position-independent fastening means,

FIG. 5b shows a second view of an exemplary embodiment of the position-independent fastening means,

FIG. 6 shows an exemplary embodiment of an arrangement for releasing a component of the cup system,

FIG. 7a shows a first view of an exemplary embodiment of a dispenser system according to the invention,

FIG. 7b shows a second view of an exemplary embodiment of a dispenser system according to the invention,

FIG. 8 shows an exemplary embodiment of a holding device for releasable attachment of at least one dispenser,

FIG. 9 shows a further exemplary embodiment of a holding device for releasable attachment of at least one dispenser,

FIG. 10 shows a further exemplary embodiment of a dispenser system according to the invention, consisting of the holding device from FIG. 8, equipped with the dispensers from FIGS. 1 to 4,

FIG. 11 shows a further exemplary embodiment of a dispenser system according to the invention, consisting of the holding device from FIG. 9, equipped with the dispensers from FIGS. 1 to 4, and

FIG. 12 shows an embodiment of a suspension device for storing a component in a suspended manner.

### DETAILED DESCRIPTION OF THE DISCLOSURE

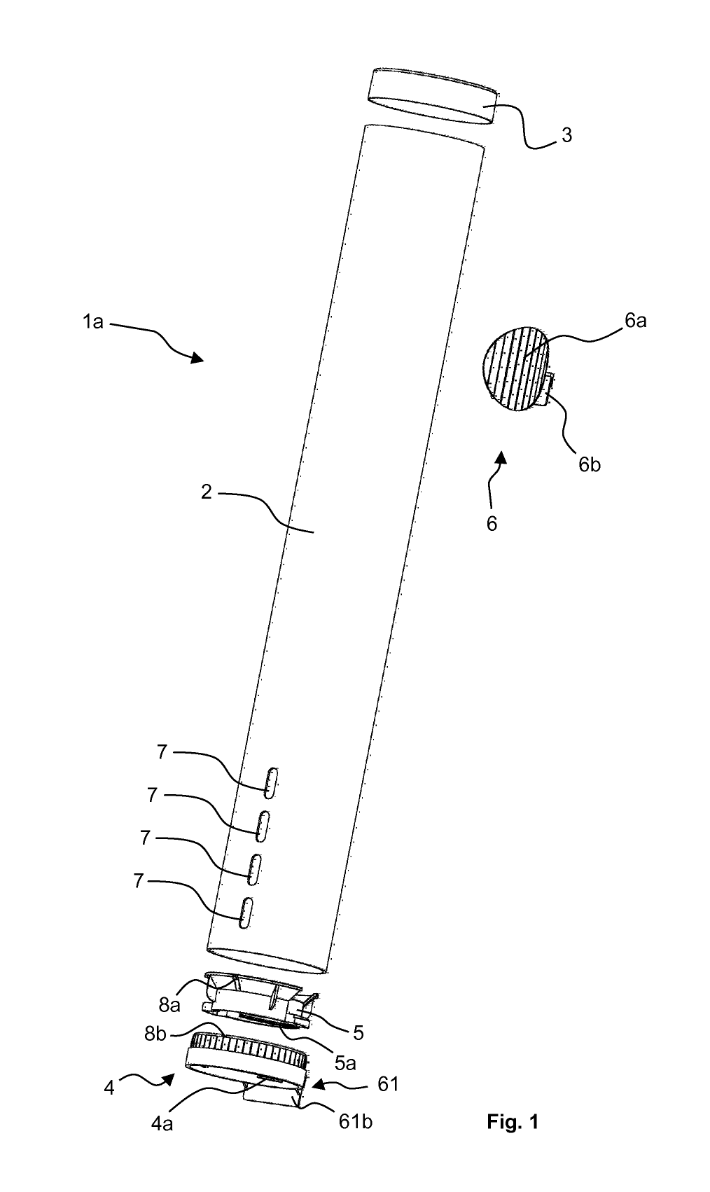

FIG. 1 shows a first exemplary embodiment of a dispenser according to the disclosure, which in this case is designed as dispenser 1a for approximately 60 known cup containers for paints or varnish for use with paint spray guns, said cup containers being substantially frustoconical, being provided with a base and having a capacity of approximately 600 or 900 ml. The dispenser 1a consists substantially of a tubular receiving body 2 for receiving cup containers, a lid 3, an arrangement 4 for releasing the components, and a position-independent fastening means 6. An adaptor 5, which makes the dispenser suitable in this case for use with smaller cup systems, is additionally shown in FIG. 1.

The receiving body 2 of the dispenser 1a has a fill level indicator in the form of a plurality of relatively small viewing windows 7, with the aid of which the user can identify when only few cup containers are still located in the receiving body 2 and the dispenser should be refilled. The viewing windows 7 can also be arranged over the entire length of the receiving body 2 so that the user can continuously estimate the number of containers still present. Only one single viewing window may also be provided, preferably as low down as possible, or one single long viewing window, for example reaching over practically the entire length, or a plurality of viewing windows distributed over the circumference.

The lid 3 is fitted merely onto the receiving body 2 in the present exemplary embodiment. However, it may also be provided as a screw closure or in another form. The arrangement 4 for releasing the components has a plurality of thread parts 4a corresponding to the thread of the cup containers and also a fastening means 61 connected fixedly to the arrangement 4 for releasable detachment of the dispenser 1a to a holding device, wherein merely the holding plate 61b of the fastening means 61 is visible in FIG. 1. The holding arms on the rear side of the holding plate 61b are not visible in FIG. 1. The arrangement 4 can be plugged releasably onto the receiving body 2 and for this purpose has an overlap region, which can be plugged into the receiving body 2. The adapter 5 has a smaller diameter than the arrangement 4 and in the present case has longer thread parts 5a. The adapter 5 further has a lug 8a, which can be inserted into a groove 8b in the arrangement 4. The adapter 5 is thus fixed on the arrangement 4 in a manner secured against rotation. The arrangement 4 and adapter 5 are preferably interconnected by means of a plug-in, clip, or snap-fit connection, or the adapter 5 is merely introduced into the arrangement 4 before the two component parts are together attached to, or in, the receiving body 2. The position-independent fastening means 6 has an adhesive area 6a, which may be self-adhesive or can be provided with an adhesive. Furthermore, the fastening means 6 has a region 6b, which is L-shaped in the present case and with the aid of which the fastening means 6 can be hooked into a holding device before the dispenser 1a is connected to the fastening means 6. The fastening means 6 preferably consists of a plastic and, in its adhesive area 6a, has a plurality of grooves, which enable uniform bending of the adhesive area 6a. The adhesive area can thus be adapted to differently sized circumferences and therefore to differently sized dispensers.

To fill the dispenser 1a, the lid 3 is removed from or out from the receiving body 2 and the cup containers, advantageously in a stacked manner and with the base first, are allowed to fall into the receiving body 2 or are slid thereinto or introduced thereinto in another way. The outer thread of the lowermost cup container comes to rest on the thread parts 4a and 5a. The majority of the cup container protrudes downwardly from the dispenser 1a. The user can grasp this part of the cup container and release it from the arrangement 4 or the adapter 5 by means of a rotation.

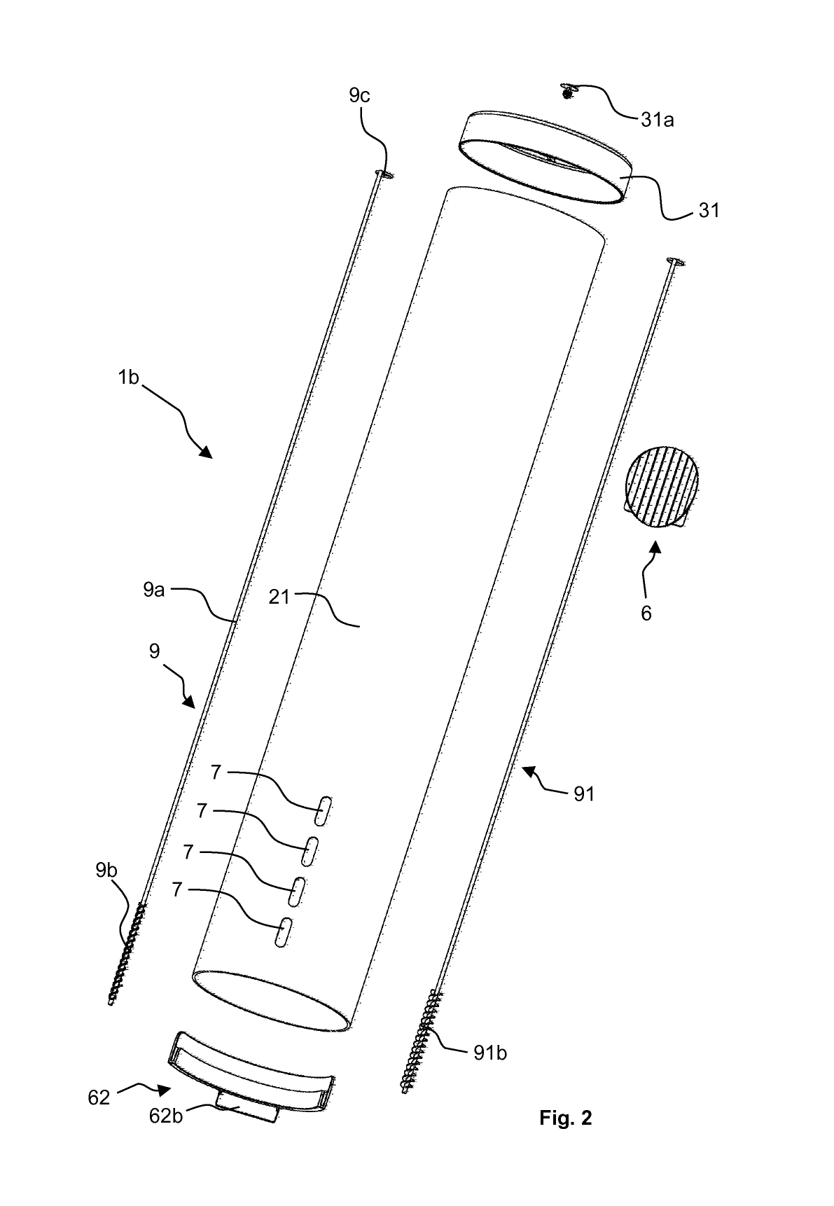

FIG. 2 shows a second exemplary embodiment of a dispenser according to the invention. In this case, it is designed as a dispenser 1b for cup lids (not illustrated here). The cup lids may have a circular, disc-shaped outer contour and a ventilation hole in the middle, which can be closed as required, or may be substantially conical and preferably fitted in the region of the centre line with a tubular connection fitting for the paint spray gun. Such cup lids of the latter-mentioned type are used in what are known as upside-down paint spraying systems. The dispenser 1b, similarly to the dispenser 1a, consists of a tubular receiving body 21 with viewing windows 7, wherein the receiving body 21 has a slightly larger diameter than the dispenser 1a for the cup containers, since the cup containers in the present exemplary embodiment have a smaller outer diameter than the cup lids. Should the cup lids have a smaller diameter than the cup containers, the dimensions are of course reversed. In the present exemplary embodiment, the dispenser 1b may preferably accommodate the same number of cup lids as the dispenser 1a for the cup containers, whereby it can be ensured that an entire set formed of cup and lid is simultaneously available when the two dispensers are used together.

The lid 31 of the dispenser 1b has an opening (not visible in FIG. 2) on its upper side, into which a fastening rivet 31a can be inserted. This rivet 31a, via an eyelet 9c, holds the suspension device 9, which for reasons of improved clarity is illustrated outside the receiving body 2. During use, it hangs inside the receiving body however. The suspension device 9 can also be fastened to the lid 31 by other fastening types however, such as jamming, welding, adhesive bonding, pressing, by magnetic or pneumatic means, or otherwise.

The suspension device 9 consists of a main body 9a, which can be formed of wound wire, and a stop device 9b, which is illustrated in FIG. 2 as a double helix which is preferably formed by bristles however. In FIG. 2, a second suspension device 91 is illustrated, in which the stop device 91b is wider than the stop device 9b. It is thus suitable for receiving cup lids having a greater connection diameter compared to the suspension device 9. The dispenser 1b can also be designed to receive upwardly open standard gravity-flow cups with outlet fitting at the bottom. The suspension devices 9 and 91 can be used alternatively depending on the type of cup or cup lid.

The dispenser 1b further has a fastening means 62 for releasable attachment of the dispenser 1b to a holding device, wherein the fastening means 62 has at least one holding plate 62b and, on the rear side thereof, holding arms or the like (not visible in FIG. 2). The fastening means 62 can be plugged releasably or non-releasably onto the receiving body 21 and forms a position-dependent fastening means. The dispenser 1b also has a position-independent fastening means 6, which may be designed identically to the fastening means with the dispenser 1a. Due to the flexible adhesive area, the fastening means can adapt without difficulty to the diameter of the receiving body 21, which is larger in the present case.

To fill the dispenser 1b, the lid 31 thereof is removed from the receiving body 21 together with the suspension device 9 or 91 fastened thereto. The cup lids, which are provided with a hole or a connection fitting with an outlet opening and by means of which the dispenser 1b is to be filled, are advantageously provided in stacked form. The connection openings of the cup lids thus form a type of channel, through which the suspension device 9 or 91 can be guided. The suspension device 9 or 91 is preferably introduced into the lid stack until the stop device 9b or 91b emerges at least in part, but advantageously completely, from the lowermost cup lid. The suspension device 9 or 91 can then be introduced together with the cups into the receiving body 21 until the cover 31 rests on the receiving body 21. The lowermost cup lid then protrudes to some extent from the dispenser 1b from below and can be drawn downwards for removal.

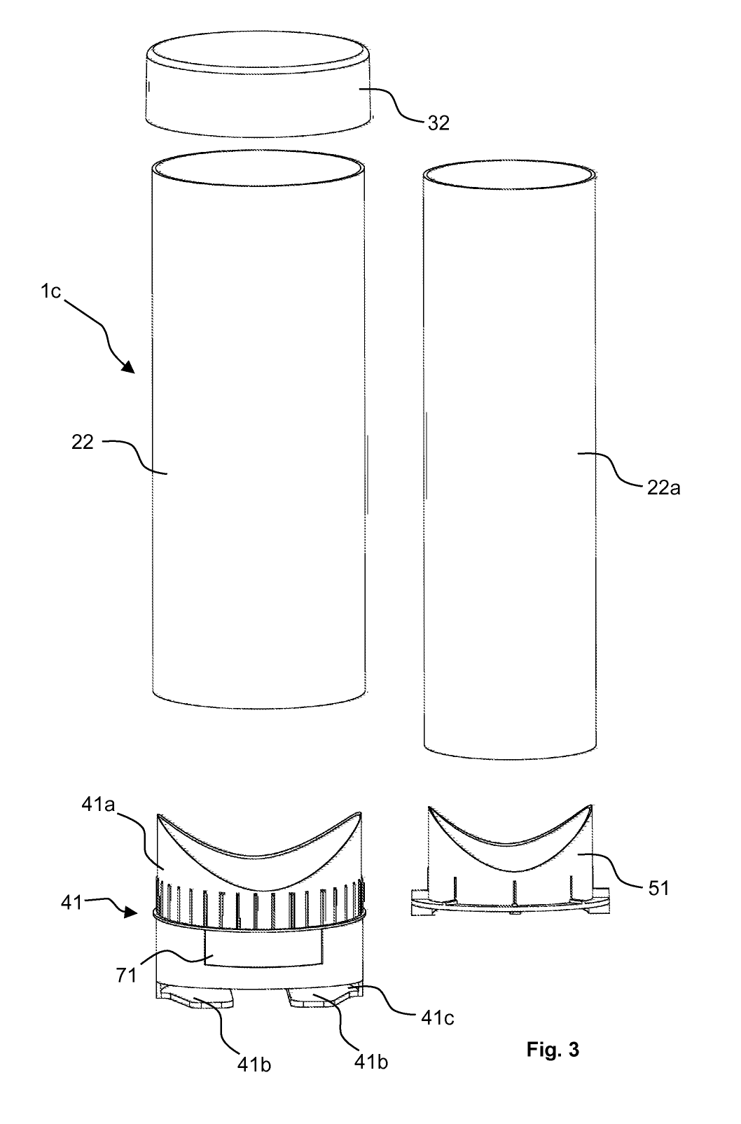

A further exemplary embodiment of a dispenser according to the invention is shown in FIG. 3. There, it is present in the form of a dispenser 1c for round flat sieves. Besides a receiving body 22 and a lid 32, the dispenser 1c has an arrangement 41 for releasing the components, which, on its underside, has two tongues 41b with a gap. A slitted opening 41c is located on the front side of the arrangement 41. A viewing window 71 is formed in the arrangement 41 so that the user can identify when only few flat sieves are still located in the receiving body 22. The viewing window can also be located in the receiving body 22 however.

The receiving body 22 can be shorter than the receiving bodies 2 and 21 from FIGS. 1 and 2, since the flat sieves require less space when stacked than the same number of stacked cup lids or cup containers. It may therefore be sufficient to attach the dispenser 1c to the holding device just at one single holding point. For this purpose, a fixed fastening means (not visible in FIG. 3) can be used and may be located on the rear side of the arrangement 41. A position-independent fastening means is not necessary in this case, but may be provided however if the hold of the dispenser 1c is to be improved. The arrangement 41 has a relatively broad overlap region 41a, which can be plugged into the receiving body 22. The overlap region 41a has, on its surface, a fluting or a plurality of webs, which generates a greater resistance to rotation of the arrangement 41 compared to a smooth surface.

To fill the dispenser 1c, the flat sieves are allowed to fall, advantageously in a stacked manner, into the upper opening of the receiving body 22. The lowermost flat sieve in the stack comes to rest on the tongues 41b. The lowermost flat sieve can be removed when the user presses lightly against the flat sieve with his finger between the tongues 41b and pulls the flat sieve in the direction of the opening 41c.

Besides the dispenser 1c, FIG. 3 shows an adapter system in the form of a further receiving body 22a and an insert 51. These component parts are used when a smaller flat sieve is to be used, for example for use in a smaller cup container or cup lid, than is provided for the dispenser 1c. The receiving body 22a and insert 51 reduce the inner diameter of the dispenser 1c and thus ensure a more stable mounting and release of the smaller flat sieves. The insert 51 is for this purpose inserted, together with the receiving body 22a connected thereto, into the arrangement 41 before the receiving body 22 is slid over the receiving body 22a and the overlap region 41a.

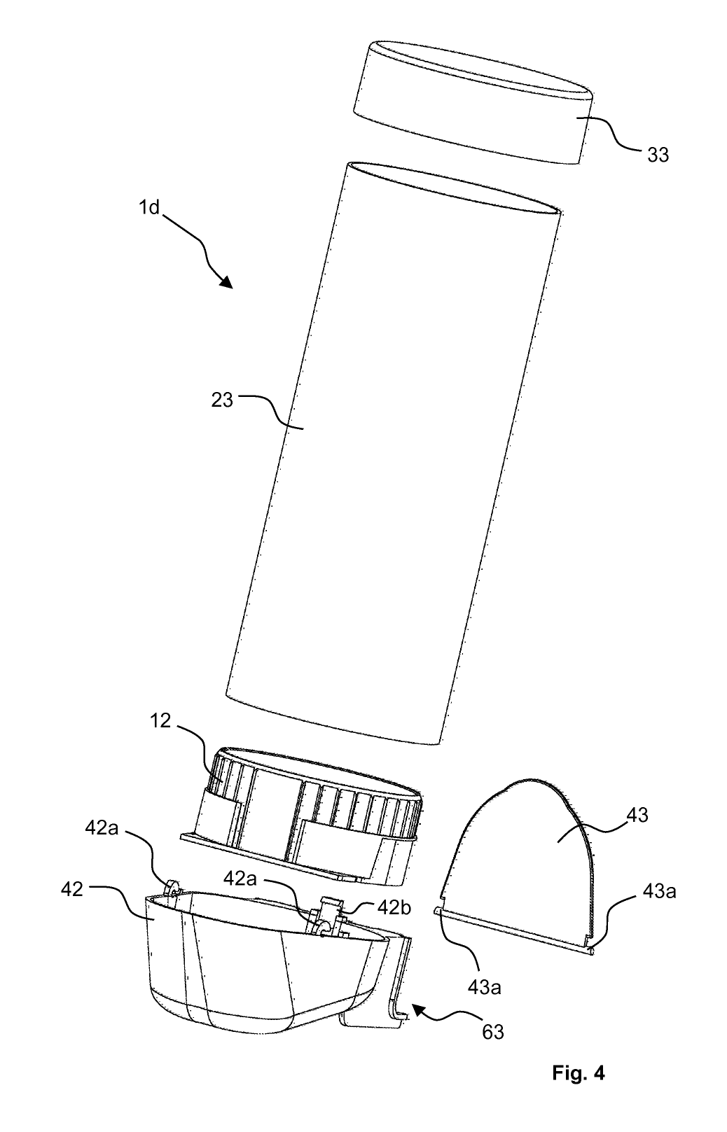

A further exemplary embodiment of the dispenser according to the invention is illustrated in FIG. 4, in this case in the form of a dispenser 1d for plug-in sieves. Besides a receiving body 23 and a lid 33, the dispenser has a sleeve 12 and an arrangement 42, which is trough-shaped in the present case, for removal of the plug-in sieves and a flap 43 for the arrangement 42. The flap 43 has two webs 43a, which can be clipped into two hooks 42a on the arrangement 42 in order to attach the flap 43 to the arrangement 42 such that it can be opened and closed. The arrangement 42 can be attached to the sleeve 12 by means of a snap-fit device 42b and a corresponding groove (not visible in FIG. 4). The sleeve 12 can in turn be plugged into the receiving body 23. A fastening means 63 connected to the arrangement 42 and therefore position-dependent is arranged on the rear side of said arrangement.

To fill the dispenser 1d, the plug-in sieves are tipped or thrown loosely into the receiving body 23. They then fall into the arrangement 42 and can be removed therefrom once the flap 43 has been lifted.

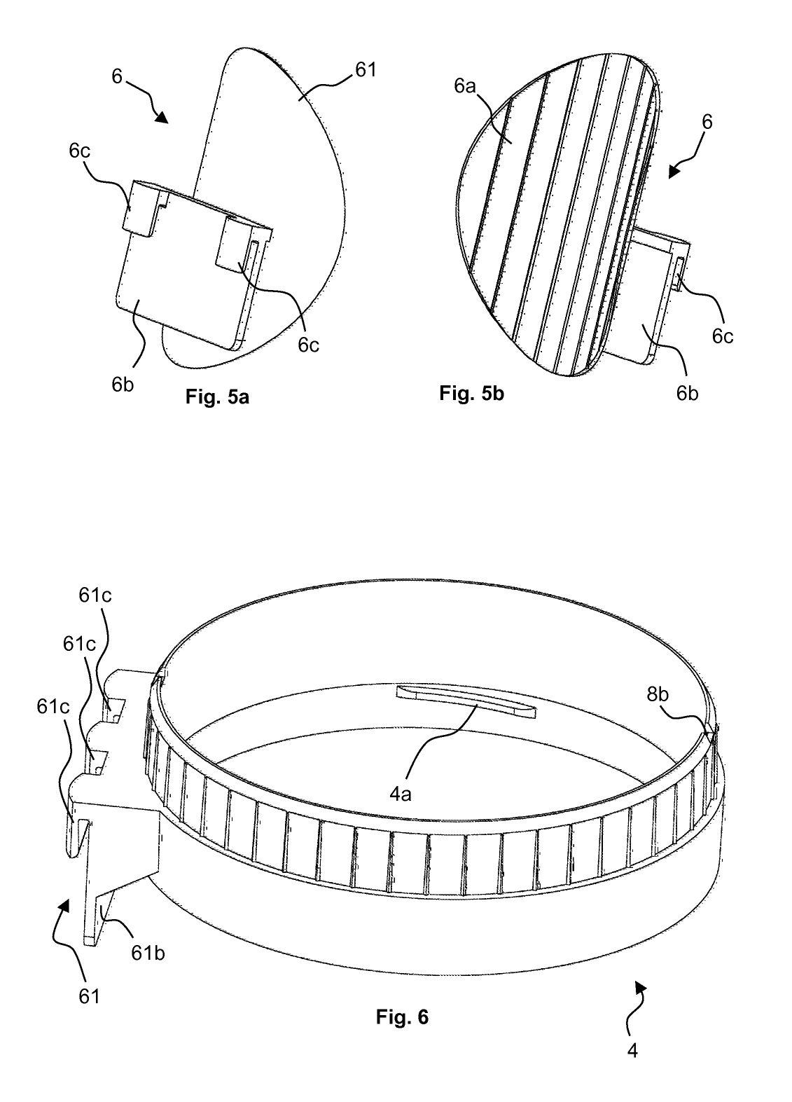

FIGS. 5a and 5b show an exemplary embodiment of a position-independent fastening means 6 for releasable attachment of a dispenser to a holding device. The fastening means 6 comprises an adhesive element 61 with adhesive area 6a, a holding plate 6b and L-shaped holding arms 6c. The adhesive area 6a is provided with a plurality of grooves, whereby the adhesive element 61 is more flexible and can adapt to differently sized dispensers. The contact area between the adhesive element 61 and holding plate 6b has to be large enough to produce a secure connection between the two components, but must also be as small as possible so that the adhesive element can be bent in the best possible manner.

FIG. 6 shows the arrangement 4 for releasing the components, which was shown in FIG. 1 together with the dispenser 1a, from a different perspective from FIG. 1. The arrangement 4 comprises a fastening means 61 for releasable attachment of the dispenser to a holding device, which consists substantially of a holding plate 61b and three holding arms 61c. The fastening means 61 is fixedly connected to the arrangement 4. Such a fixed fastening means, which is connected non-releasably to another component, can generally take up greater forces than a fastening means 6 that is to be attached subsequently and is shown in FIGS. 5a and 5b. The dispensers are therefore initially attached to the holding device via their fixed fastening means. The fixed fastening means thus supports the majority of the weight of the dispenser. A fastening means 6 that is to be attached subsequently and is shown in FIGS. 5a and 5b serves rather to prevent a tilting of the dispenser in a forward direction. The fixed fastening means 61 therefore also comprises three holding arms 61c, whereas the fastening means 6 from FIGS. 5a and 5b comprises only two holding arms 6c. The arrangement 4 further comprises a plurality of thread parts 4a and at least one groove 8b, which have already been described further above.

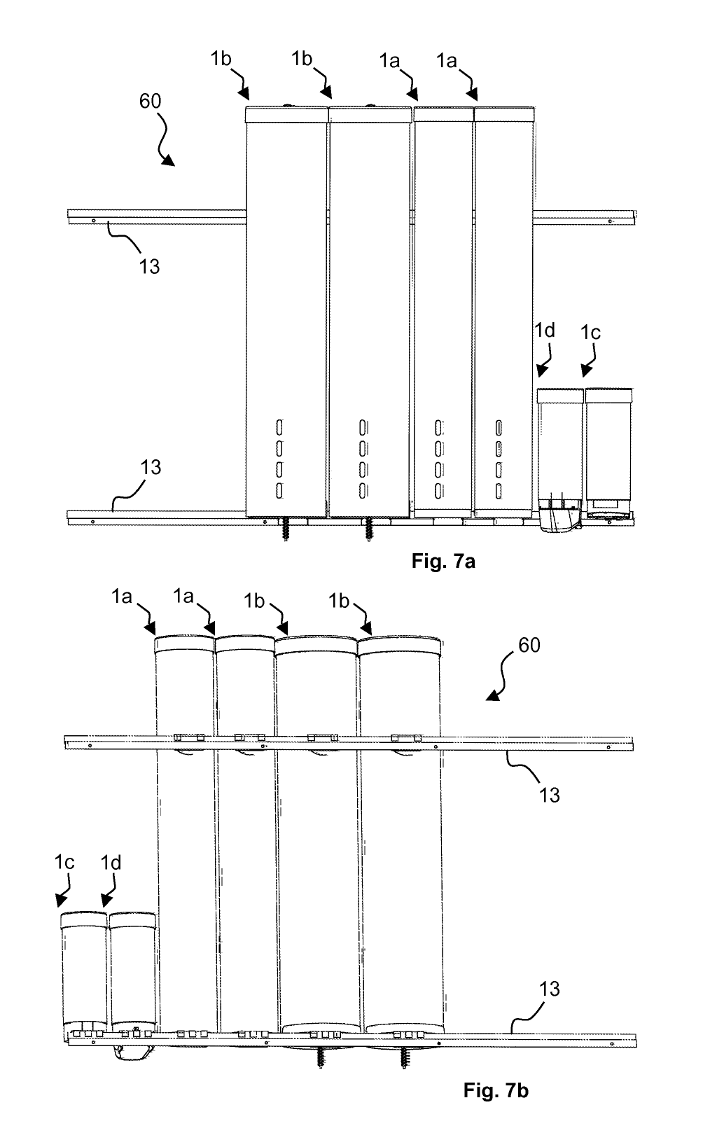

FIG. 7a shows the front side of an exemplary embodiment of a dispenser system 60 according to the invention, which in the present case comprises the dispensers 1a, 1b, 1c and 1d and also a holding device 13 for releasable attachment of the dispensers 1a, 1b, 1c and 1d. In the present exemplary embodiment, the holding device 13 is provided in the form of two rails, which can be screwed to a wall. The dispensers 1a, 1b, 1c and 1d can then be hooked into the rails via their fixed fastening means and/or their position-independent fastening means to be attached subsequently, more preferably in the above-described manner.

FIG. 7b shows the rear side of the exemplary embodiment of a dispenser system 60 according to the invention from FIG. 7a. It can be seen that two holding points are provided for each of the dispensers 1a and 1b, wherein one holding point is located on the upper rail and a second holding point is located on the lower rail. The dispensers are held on the lower rail by a fixed fastening means having three holding arms and are held on the upper rail by a subsequently attached fastening means having two holding arms. The arrangement can also be swapped however. For example, the receiving body of a dispenser can be provided at the upper region with a holding ring, on which a fastening means connected fixedly thereto is arranged, by means of which the dispenser can be hung on the lower rail. The dispenser can be held on the lower rail by a subsequently attached fastening means. The dispensers 1c and 1d are shorter than the dispensers 1a and 1b and are only each attached to the holding device 13 via one holding point. Due to the short length of the dispensers 1c and 1d, no large torques act on the lower fastening means. It is therefore sufficient to fit the dispensers 1c and 1d on the lower rail by just one fixed fastening means. The dispensers may of course also be fitted or suitable for fitting on the upper rail. A third rail can also be provided between the two other rails and holds the dispensers 1c and 1d at their upper region. The dispensers 1c and 1d can also be designed with a fastening means to be attached subsequently.

FIG. 8 shows an exemplary embodiment of a holding device for releasable attachment of at least one dispenser, which differs from the exemplary embodiment from FIGS. 7a and 7b. In this case, it is designed as a standing holding device 14, in particular to be stood on a table or on another elevation. The holding device 14 consists substantially of a column 14a, three multi-sided plates 14b, which are penetrated in their centre by the column 14a, a base plate 14c, and fixing arrangements in the form of two rotary knobs 14d. The edges of the plates 14b are bent substantially perpendicularly upwards and thus form receptacles for the fastening means of the dispensers. At least one dispenser can thus be attached on each side of the plates 14b. The column 14a may consist of a plurality of tubes and rods, which can be plugged into one another as far as desired in order to form the column 14a and therefore the holding device 14 preferably so as to be height-adjustable in a telescope-like manner and rotatable. In order to form the holding device 14 as a holding device that can be stood on the floor, the column 14a can be displaced on or relative to the short column piece 14a1 and can be fixed in terms of height by means of the two rotary knobs 14d1 and 14d2. The short column piece 14a1 can be fixed on the base plate 14c, in particular in a manner fixed against rotation, by means of the lower rotary knob 14d2. The short column piece 14a1 can be replaced by a longer piece, whereby the plates 14b are increased and the height adjustability can be extended. The columns 14a and/or 14a1 and/or the plates 14b are preferably mounted rotatably, in particular with respect to the base plate 14c, and can be removed or disassembled from the base plate 14c. The entire holding device 14 can particularly preferably be disassembled completely or largely into its individual parts.

The base plate 14c is square in the present exemplary embodiment, but could also be rectangular, round or oval. Its dimensions are selected such that the filled system is secured against tilting.

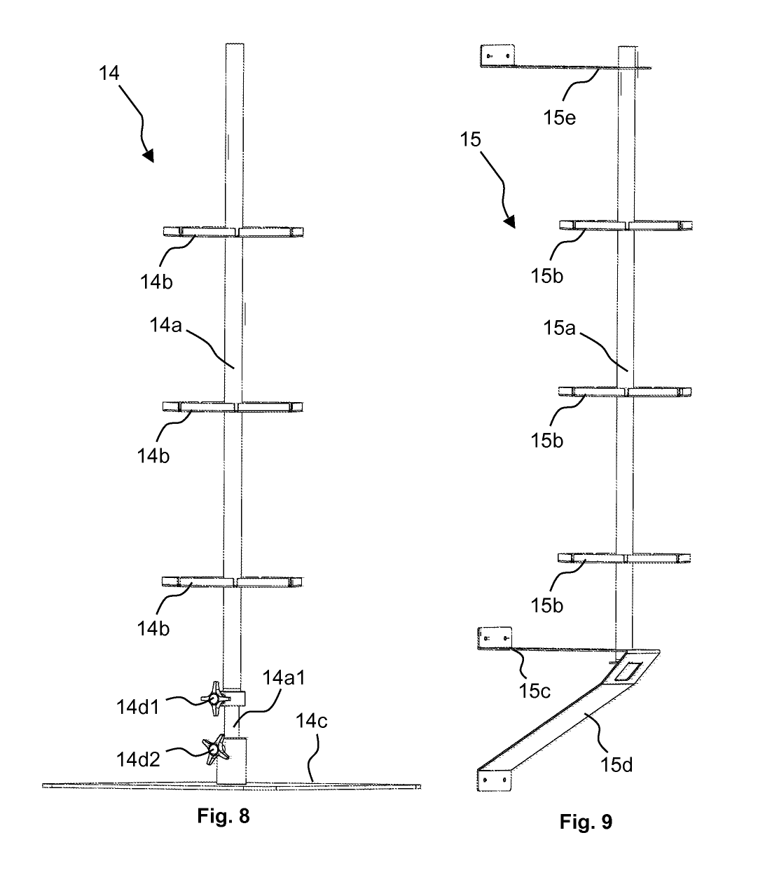

FIG. 9 shows a further exemplary embodiment of a holding device for the releasable attachment of at least one dispenser. In this case, the holding device 15 is designed for attachment to a wall. This exemplary embodiment also comprises a column 15a and three multi-sided plates 15b with upwardly bent edges. In contrast to the exemplary embodiment in FIG. 8, the holding device 15 comprises no base plate however, but an arrangement for mounting the holding device 15 on a wall. This arrangement consists of a horizontal part 15c and a strut 15d on the underside of the column 15a and a horizontal part 15e on the upper side of the column 15a. The column 15a is preferably supported rotatably in the arrangement for mounting of the holding device 15 on a wall. The column 15a with its plates 15b can be releasable from the assembly arrangement. For example, the upper horizontal part 15e may comprise a receptacle for releasable attachment of the column 15a, for example a snap-fit or flap arrangement, whereby the column 15a can be released by drawing the column 15a away from the horizontal part 15e. The lower horizontal part 15c can be designed in such a way that the column 15a merely has to be inserted. The column 15a is also mounted preferably rotatably here and can be disassembled.

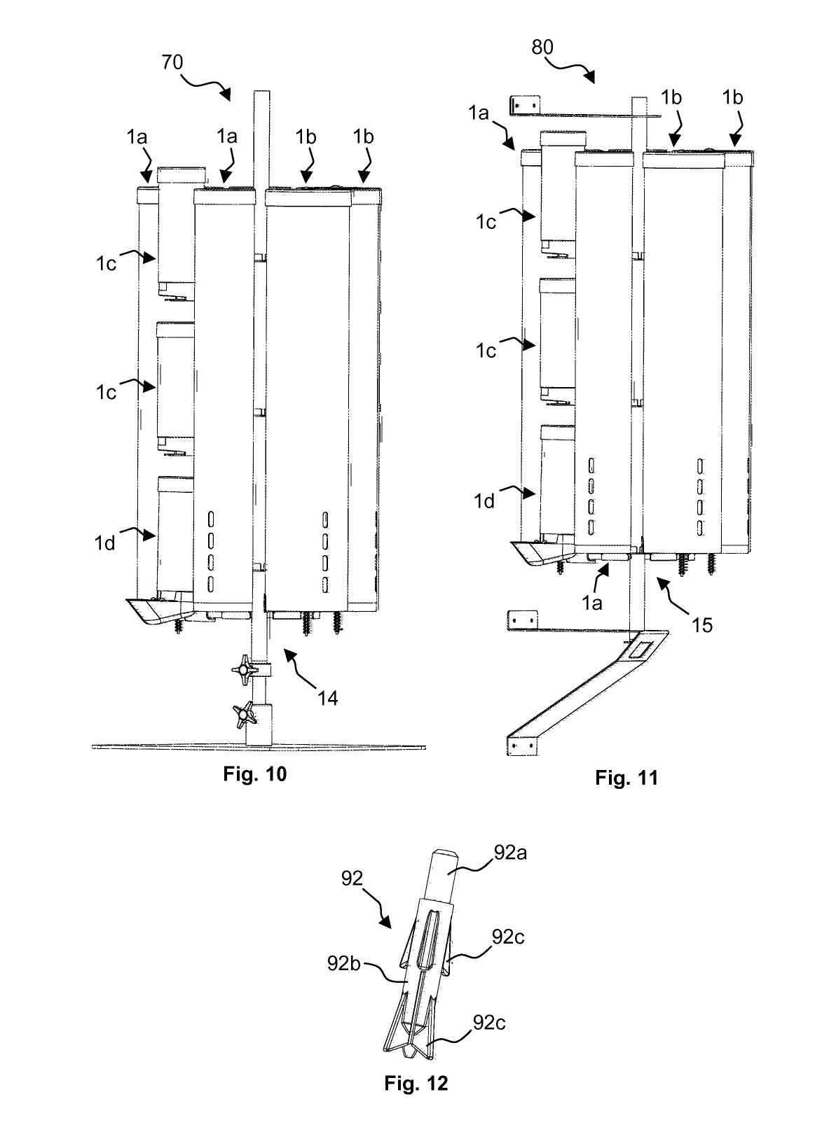

FIG. 10 shows a further exemplary embodiment of a dispenser system according to the invention. By contrast to the dispenser system 60 shown in FIGS. 7a and 7b, the dispenser system 70 comprises no rails able to be mounted to the wall, but uses the holding device 14 from FIG. 8, which is equipped with the dispensers from FIGS. 1 to 4. The long dispensers 1a and 1b are preferably fastened to the lower and to the upper plate of the holding device 14. The shorter dispensers 1c and 1d are each fastened to a plate, as a result of which, with sufficient spacing between the plates, it is possible to arrange three dispensers one above the other.

FIG. 11 shows a further exemplary embodiment of a dispenser system according to the invention. This dispenser system 80 does not comprise any rails able to be mounted to the wall, but uses the holding device 15 from FIG. 9, which is equipped with the dispensers from FIGS. 1 to 4. The long dispensers 1a and 1b are also fastened here preferably to the lower and to the upper plate of the holding device 15. The shorter dispensers 1c and 1d are again each fastened to a plate, as a result of which, with sufficient spacing between the plates, it is possible to arrange three dispensers one above the other.

Part of a suspension device 92 is shown in FIG. 12 and can be used as an alternative to suspension devices 9 and 91 shown in FIG. 2. Similarly to the suspension devices 9 and 91, the suspension device 92 has a main body 92a, of which only a small part is shown in Figure and which can also be formed from wound wire or fabricated from plastic, for example injection moulded or extruded, and a stop device 92b, which in the present form comprises a plurality of hooks 92c, which hold the components on the suspension device 92 and serve as alternatives to the bristles of the suspension devices 9 and 91. Stop devices in the form of thickened portions, expanding mandrels or the like may also be provided instead of the hooks 92c.

The different elements of the holding devices 13, 14 and 15 can be combined with one another arbitrarily such that the dispenser system according to the invention can be stood on or attached to different points, moreover in different ways.

Lastly, it is noted that the described exemplary embodiments only describe a limited selection of possible embodiments and therefore do not limit the present disclosure.

The dispensers according to the disclosure, in addition to the use in paint cup systems in paint shops, can of course also be used in other trade areas, industry areas or other fields, for example in pharmaceutical or medical fields or in retail outlets or in restaurants.

What is claimed is:

1. Dispenser for at least one component of a cup system, in particular a paint cup system, said dispenser comprising at least one receiving body for receiving the component and an arrangement for releasing the component, wherein the dispenser comprises at least one fastening means for releasable attachment of the dispenser to a holding device.

2. Dispenser according to claim 1, wherein it comprises a suspension device for storing the component in a suspended manner.

3. Dispenser according to claim 2, wherein the suspension device can be attached to a lid on the receiving body.

4. Dispenser according to claim 2, wherein the suspension device is designed at least in regions as a brush, in particular as a round brush.

5. Dispenser according to claim 1, wherein the arrangement for releasing the component is designed as a collecting tray, in particular for plug-in sieves.

6. Dispenser according to claim 1, wherein arrangement for releasing the component comprises, on its underside, at least two tongues and, on at least one other side, a slitted opening.

7. Dispenser according to claim 1, wherein the arrangement for releasing the component is designed in such a way that it corresponds to at least one thread of the component.

8. Dispenser according to claim 1, wherein it comprises at least one arrangement for displaying user information.

9. Dispenser according to claim 1, wherein at least one fastening means is connected or connectable to a component part of the dispenser in a position-dependent manner.

10. Dispenser according to claim 1, wherein at least one fastening means can be attached to the dispenser by means of an adhesive, detent, snap-fit or other rapid connection.

11. Dispenser according to claim 1, wherein at least one fastening means can be attached in a position-independent manner to the dispenser.

12. Dispenser for at least one component of a cup system, in particular a paint cup system, wherein it is designed to receive an adapter, which makes the dispenser suitable for use with different or various components of the cup system.

13. Dispenser system for at least one component of a cup system, in particular a paint cup system, said dispenser system comprising at least one dispenser, wherein the dispenser system further comprises a holding device for releasable attachment of the at least one dispenser.

14. Dispenser system according to claim 13, wherein it is formed in a modular manner and can be equipped with different dispensers.

15. Dispenser system according to claim 13, wherein it can be equipped at least with one dispenser for paint cup containers, one dispenser for paint cup lids, one dispenser for flat sieves and one dispenser for plug-in sieves.

16. Dispenser system according to claim 13, wherein at least one dispenser is designed according to claim 1.

17. Dispenser system according to claim 13, wherein the holding device comprises at least one column and a plurality of receiving arrangements for receiving at least one fastening means of a dispenser.

18. Dispenser system according to claim 17, wherein the receiving devices are arranged on the holding device in at least two planes.

19. Dispenser system according to claim 13, wherein the holding device comprises at least one plate for standing the holding device on the floor.

20. Dispenser system according to claim 13, wherein the holding device comprises at least one arrangement via which the holding device can be mounted to a wall.

21. Dispenser system according to claim 13, wherein the holding device comprises at least one rail that can be mounted to a wall.

22. Dispenser system according to claim 13, wherein the holding device comprises at least one L-shaped, U-shaped or Z-shaped region, and in that at least one fastening means on the dispenser comprises a corresponding L-shaped, U-shaped or Z-shaped region, whereby the fastening means can be hooked into the holding device.
